(19) United States
(12) Patent Application Publication
(10) Pub. No.: US 2003/0074576 A1
(43) Pub. Date: Apr. 17, 2003

(54) Positive disconnect device for networked computer

(76) Inventor: Thomas W. Kelly, Detroit, MI (US)

Correspondence Address: Robert K. Roth, Miller, Canfield, Paddock & Stone, P.L.C., 150 W. Jefferson, Suite 2500, Detroit, MI, 48226, US

(21) Appl. No.: 09/982,082

(22) Filed: Oct. 17, 2001

(51) Int. Cl. H04L 9/00

(52) U.S. Cl. 713/200

(57) ABSTRACT

A computer security system for protecting a computer from viruses and other unauthorized data transmittal is disclosed. The computer is connected to a data generation device, such as the Internet. The data generation device generates an input signal which is received by the computer when connected to the data generation device. The security system comprises a user interface which generates an output signal, a networking device which receives the input signal from the data generation device when connected with the data generation device, and a positive disconnect device which selectively prevents operative connection between the networking device and the data generation device when the output signal corresponds to a preselected period of inactivity of the user interface.

### FIELD OF THE INVENTION

This invention relates to networked computers, and more particularly, to a positive disconnect device for isolating a networked computer from the network.

### BACKGROUND OF THE INVENTION

Networked computers and computers with Ethernet connections are common today, and will be more common in the future. Computers which can communicate with other devices have numerous advantages. Information of all kinds and in many different formats can be sent to other computers and information of all kinds and in many different formats can be received from other computers. As this has been found to be of considerable value, increasingly connections with outside computers are maintained continuously, even if there is a prolonged period of inactivity by a user of the computer. This is done in the name of expediency, especially with personal computers (PCs) which are disheartening slow to reach a state where it can receive instructions after it has been turned on.

However, along with these advantages come certain potential disadvantages. Computer programs which deliberately damage the software of computers that they infest are known as viruses. Many viruses can be created in one place and then transmitted over the Internet via receipt of an e-mail message or otherwise as an attachment to data sent to the computer from outside the computer. Anti-viral software can scan many existing files and incoming files and delete or block such viruses, but those who create viruses are continually looking for ways to defeat the various known security measures which have been developed. As long as the computer is in communication with the outside world, the potential for receiving a virus which would damage the computer's software exists. It would be desirable to provide a simple, straightforward way to protect computers from receiving viruses, especially during prolonged periods of inactivity by the user.

### SUMMARY OF THE INVENTION

In accordance with a first aspect, a computer security system for a computer connected to a data generation device (such as a networked computer) is provided. The data generation device generates an input signal which is received by the computer when connected to the data generation device. The security system comprises a user interface which generates an output signal, a networking device which receives the input signal from the data generation device when connected with the data generation device, and a positive disconnect device which selectively prevents operative connection between the networking device and the data generation device when the output signal corresponds to a preselected period of inactivity of the user interface.

From the foregoing disclosure and the following more detailed description of various preferred embodiments it will be apparent to those skilled in the art that the present invention provides a significant advance in the technology and art of computer security systems. Particularly significant in this regard is the potential the invention affords for providing a high quality, low cost security system with high reliability. Additional features and advantages of various preferred embodiments will be better understood in view of the detailed description provided below.

### BRIEF DESCRIPTION OF THE DRAWINGS

FIG. 1 is a schematic of a networked computer with a positive disconnect device for the network in accordance with a first preferred embodiment where the positive disconnect device is a separate plug-in to a computer.

FIG. 2 is a schematic of a networked computer with a positive disconnect device in accordance with a second preferred embodiment where the positive disconnect device is part of a network interface card.

FIG. 3 is a schematic of a networked computer with a positive disconnect device for the network in accordance with a third preferred embodiment where the disconnect device is part of the motherboard.

FIG. 4 is a schematic of a networked computer with a positive disconnect device for the network in accordance with a fourth preferred embodiment.

FIG. 5 is a schematic of a preferred embodiment of the positive disconnect device shown with relays in an open position, isolating the computer from the network.

It should be understood that the appended drawings are not necessarily to scale, presenting a somewhat simplified representation of various preferred features illustrative of the basic principles of the invention. The specific design features of the positive disconnect device as disclosed here, including, for example, the specific number of relays will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation of the damper control device illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the positive disconnect device disclosed here. The following detailed discussion of various alternative and preferred features and embodiments will illustrate the general principles of the invention with reference to a positive disconnect device suitable for use with a computer connected to the Ethernet. Other embodiments suitable for other applications will be apparent to those skilled in the art given the benefit of this disclosure.

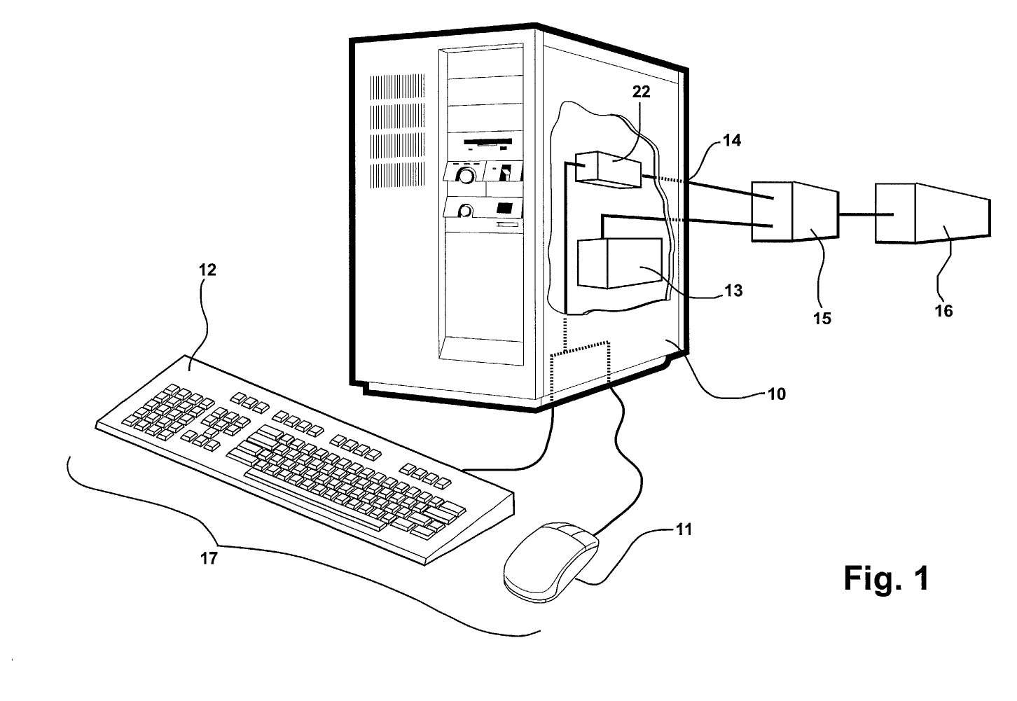

Referring now to the drawings, FIG. 1 shows a schematic of a preferred embodiment showing computer 10, with a network interface card 13, which is software and hardware which enables the computer to communicate with a network connection to the Ethernet or other networked computers. A network connection 16 connects the computer 10 to other data generation devices, and can comprise, for example, a cable modem line or a digital subscriber line (DSL). A familiar keyboard 12 and mouse 11 forms part of a user interface 17. The user interface is considered to have activity when an operator is pushing on keys on the keyboard, moving the mouse, or otherwise actively engaging the user interface so that it sends an output signal. The output signal can include information about such activity as well as instructions to be sent to other computers through the network connection 16. Other components suitable for use as part of a user interface (including, for example, touch screen monitors and game control equipment) will be readily apparent to those skilled in the art given the benefit of this disclosure.

In accordance with a highly advantageous feature, a positive disconnect device is provided between the network interface card 13 and the network connection 16. In FIG. 1 the positive disconnect device is shown as a “add-on” or “plug-in” device, which can be connected to a computer's universal series bus (USB) ports 14, typically found at the back of conventional PCs and laptops. The positive disconnect device 15 receives the output signal from the user interface, determines if there has been any user activity at any of the user interface devices 17 for a preselected period of time. If so, then the connection between the network interface card 13 and the network connection remains uninterrupted. However, if the user interface is not used for the preselected period of time, then the positive disconnect device prevents communication between the card 13 and connection 16. This advantageously protects the computer 10 from viruses or other undesired data transmission over the internet or from other networked computers, etc., while the user is not using the computer.

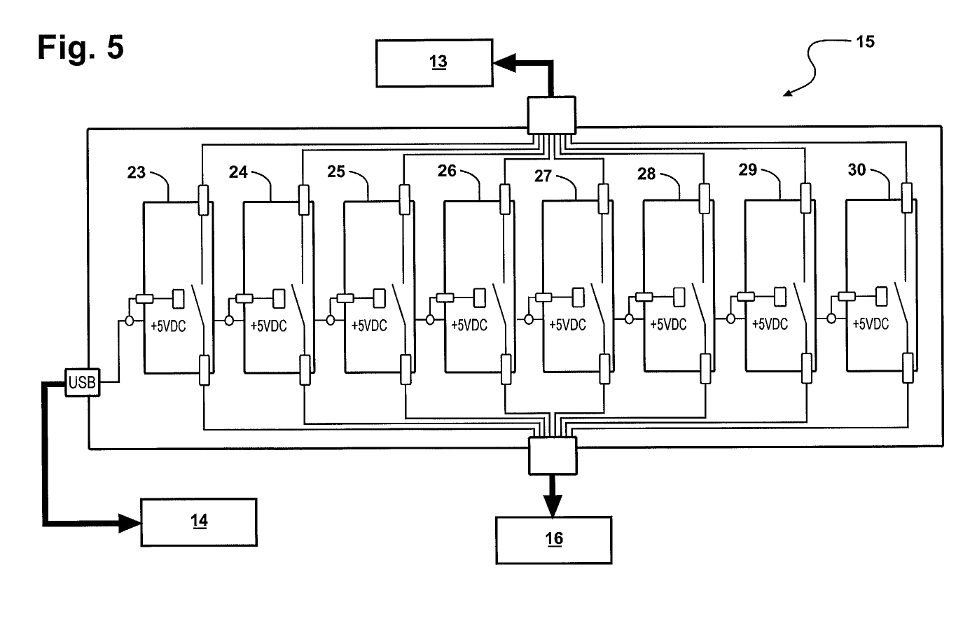

FIG. 5 shows a preferred embodiment of the positive disconnect device 15 comprising a series of electronic relays 23-30 which are shiftable from an open position to a closed position. Relays 23-30 may be, for example, normally open single pole single throw (SPST) relays. The number of relays preferably would correspond to the number of input and output signals. Current Ethernet networks carry two input signals and two output signals but are readily adaptable to go as high as eight, thus eight relays are shown. In response to a command to engage the network connection, a control voltage is applied across the relays. This keeps the relays in a position where the Ethernet connection is maintained. Then, when the output signal from the user interface indicates the preselected period of inactivity, positive disconnect device 15 removes the control voltage and the relays block the electrical communication between the network card 13 and the network connection 16. Other kinds of relays suitable for use here will be readily apparent to those skilled in the art given the benefit of this disclosure.

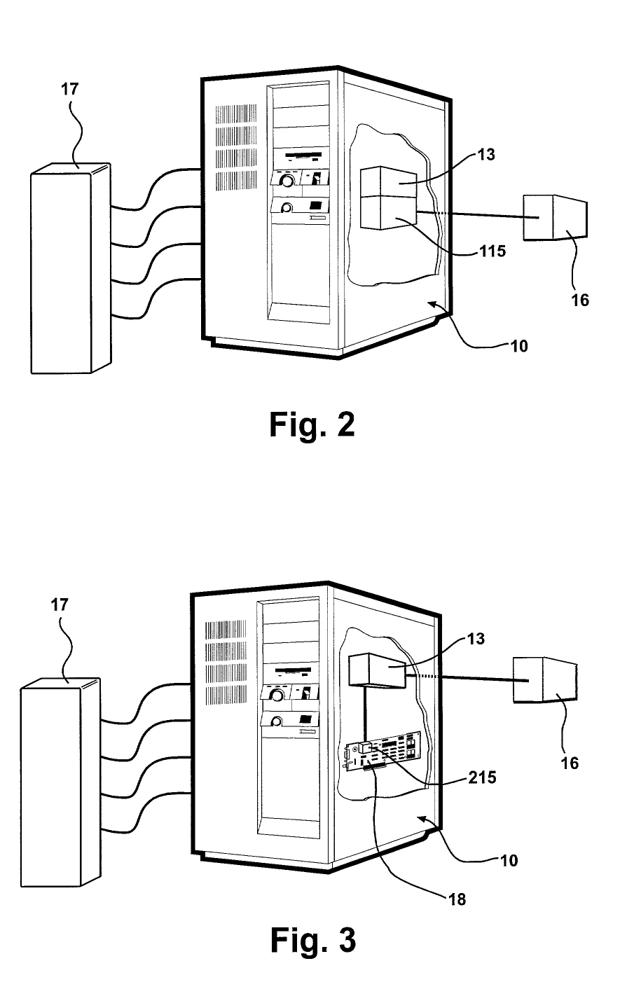

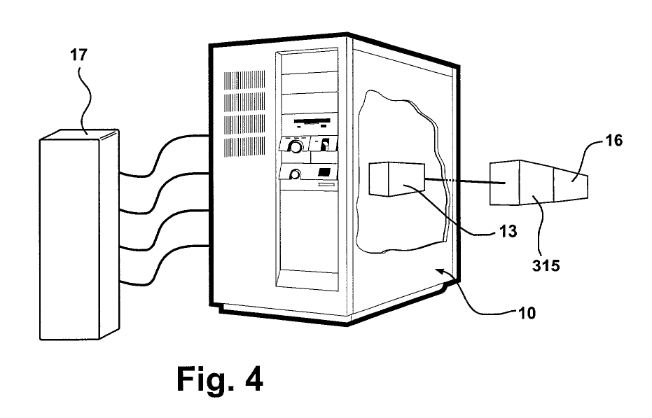

FIG. 2 shows an alternative embodiment where the positive disconnect device 115 is incorporated into the network interface card 13. FIG. 3 shows an alternative embodiment where the positive disconnect device 215 is incorporated into a motherboard 18 of the computer. Thus, the positive disconnect device can be retrofitted onto existing computers (FIG. 1) or incorporated into standard components of PCs and laptops (FIGS. 2 and 3). FIG. 4 shows another embodiment where the positive disconnect device 315 is instead of being incorporated into the computer is incorporated into the data transmission device, shown here as cable 16. It will be readily apparent to those skilled in the art that the computer will have a power supply to the Internet, and that the data transmission device will have an internet in line and internet out line.

In the embodiment shown in FIG. 1, screen saver software 22 is shown. Such screen saver software normally sets the screen on a monitor or other projection device to a default setting in response to user interface inactivity for a preselected period of time. In accordance with a highly advantageous feature, the preselected period of time before the screen saver software sets the screen to a default setting can be the same preselected period of time before the positive disconnect device 15 severs the connection between the network card 13 and the data transmission device 16. Of course, the screen saver software may be connected with the positive disconnect device of any of the preferred embodiments discussed or shown in the drawings.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A computer security system for a computer operatively connected to a data generation device, wherein the data generation device generates an input signal which is received by the computer when connected to the data generation device, the security system comprising, in combination:
a user interface which generates an output signal;
a networking device which receives the input signal from the data generation device when connected with the data generation device; and
a positive disconnect device which selectively prevents operative connection between the networking device and the data generation device when the output signal corresponds to a preselected period of inactivity of the user interface.

2. The computer security system of claim 1 wherein the positive disconnect device is positioned between the networking device and a data transmission device which transmits and receives the input signal and the output signal.

3. The computer security system of claim 2 wherein the data transmission device is a cable modem.

4. The computer security system of claim 2 wherein the data transmission device is a digital subscriber line modem.

5. The computer security system of claim 1 wherein the positive disconnect device is an add-on component attached to the computer so as to be communicatively connected to the networking device and the data generation device.

6. The computer security system of claim 1 further comprising a motherboard controlling several functions of the computer, and the positive disconnect device is integrated into the motherboard.

7. The computer security system of claim 1 wherein the positive disconnect device is incorporated into the networking device.

8. The computer security system of claim 1 wherein the positive disconnect device is incorporated into the data transmission device.

9. The computer security system of claim 1 wherein the networking device is a network interface card.

10. The computer security system of claim 1 wherein the output signal comprises information about activity of the user interface, as well as instructions to be sent to the data generation device.

11. The computer security system of claim 1 further comprising screen saver software which changes an image on a monitor after the preselected period of inactivity at the user interface so that the image on the monitor is changed at about the same time the connection to the data generation device is prevented.

12. A computer security system which communicatively isolates a computer from a data transmission device operatively connected to the Internet, comprising, in combination:
a user interface which generates an output signal;
a networking device in communication with the data transmission device, wherein the networking device transmits the output signal from the user interface and receives an input signal from the Internet through the data transmission device; and
a positive disconnect device which selectively prevents communication between the networking device and the data transmission device when the output signal corresponds to a preselected period of inactivity at the user interface.

13. The computer security system of claim 12 wherein the input signal comprises a number of signals, and the positive disconnect device comprises a series of relays, with the number of relays corresponding to the number of signals.

14. The computer security system of claim 12 wherein the positive disconnect device comprises at least one relay which in response to a control voltage is shiftable from an open position to a closed condition, and in response to the output signal corresponding to the preselected period of inactivity at the user interface, the control voltage is removed and communication between the networking device and the data transmission device is prevented.

15. The computer security system of claim 12 wherein the positive disconnect device comprises a series of electronic relays and the output signal is a preselected period of inactivity in an Internet connection command in the user interface.

16. The computer security system of claim 12 wherein the user interface comprises a keyboard and a mouse.

17. The computer security system of claim 12 wherein the positive disconnect device is a plug-in attachment which can be operatively connected to a computer.
